(19) United States
(12) Patent Application Publication
(10) Pub. No.: US 2009/0080196 A1
(43) Pub. Date: Mar. 26, 2009

(54) Lighting apparatus, lighting method, lighting system and surface information acquisition apparatus

(75) Inventors: Toshinari Shibasaki, Ibaraki-shi (JP); Katsusuke Shimazaki, Ibaraki-shi (JP); Atsuki Hirose, Ibaraki-shi (JP); Yoichi Ogawa, Ibaraki-shi (JP); Masataka Sato, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-shi (JP)

(21) Appl. No.: 12/222,582

(22) Filed: Aug. 12, 2008

(30) Foreign Application Priority Data
Sep. 20, 2007 (JP) 2007-243408
May 23, 2008 (JP) 2008-135234
Jul. 17, 2008 (JP) 2008-186058

(51) Int. Cl. F21S 10/00; F21V 3/00; F21V 7/00; F21V 7/06

(52) U.S. Cl. 362/277; 362/311.01; 362/296.01; 362/296.07

(57) ABSTRACT

A lighting apparatus includes a light source and a light beam separating member to separate light emitted from the light source into at least two different directions. The light beam separating member has a light incident plane on which light emitted from the light source is incident and a light output plane from which the light is output after being transmitted through the light beam separating member. In this structure, output light from the light beam separating member is clearly separated. Further, output light from the light beam separating member has characteristics that an angular width of each separated light beam is narrow.

### BACKGROUND OF THE INVENTION

1. Field of the Invention

The present invention relates to a lighting apparatus, a lighting method, a lighting system and a surface information acquisition apparatus.

2. Description of Related Art

A lighting apparatus is used in a wide variety of environments today. For example, a lighting apparatus is used for an image display apparatus, a testing apparatus and so on. In such uses, a lighting apparatus is required to have a high controllability in the viewing angle (irradiation direction). Particularly, in the case where the positional relationship between a light source (light emitting portion) and an object of irradiation (including a sensor or the like) is complex, a lighting apparatus is required to have a function of separating and adjusting the main direction of irradiation. Thus, it is necessary for a lighting apparatus to provide multi-directional irradiation in spite of being a single lighting apparatus.

In order to meet the requirement for multi-directional irradiation, a method of using a plurality of light sources with reflectors respectively placed on their back or side to restrict the irradiation direction has been used as shown in FIGS. 9 and 10. Further, a method of achieving multi-directional irradiation by light which is directly emitted from a light source and light which is reflected by a reflector has been used as shown in FIG. 11. Furthermore, a method of combining a reflector and a lens in one light source has been used as disclosed in Japanese Unexamined Patent Application Publication No. 2004-259451. Besides, a method of restricting light at a particular angle by placing a shielding portion on the front side of a light source (on the side facing an object of irradiation) or the like has been used.

In the method of using a reflector or a lens, the structure of a reflector or the like is complex and thick. Accordingly, such a method causes an increase in the size of a lighting apparatus. Further, the number of structural components such as a light emitting portion increases in this method. Accordingly, such a method also causes an increase in cost.

Generally, output light from one light source has a maximum light quantity at the front. Thus, in the method of achieving two-directional irradiation using a light source and a reflector as shown in FIG. 11, the most intense light is irradiated in the direction between an object of irradiation and a reflector. Accordingly, such a method causes a decrease in light use efficiency.

Further, in the method of placing a shielding portion on the front side of a light source (on the side facing an object of irradiation), luminosity is lowered. Accordingly, such a method causes excessive consumption of electric power.

### SUMMARY OF THE INVENTION

In light of the foregoing, it is desirable to provide a lighting apparatus, a lighting method, a lighting system and a surface information acquisition apparatus which separate the irradiation direction of light from a single light source into a plurality of directions.

According to an embodiment of the present invention, there is provided a lighting apparatus which includes a light source and a light beam separating member to separate light emitted from the light source into at least two different directions, wherein the light beam separating member is composed of an optical transparent member and has a light incident plane on which light emitted from the light source is incident and a light output plane from which the light is output after being transmitted through the light beam separating member. It is thereby possible to separate the irradiation direction of light from a single light source into a plurality of directions.

It is preferred that a plurality of prisms extending in one direction are formed on the light incident plane of the light beam separating member, and the light output plane of the light beam separating member is substantially flat.

It is also preferred that the light beam separating member is placed so that a peak beam traveling in a direction where a light quantity is maximum in intensity distribution characteristics of light incident on the light beam separating member is incident in a direction substantially perpendicular to the light output plane. This maximizes the effect of separating light by the light beam separating member, which maximizes light use efficiency.

The lighting apparatus preferably includes a light guide plate through which light emitted from the light source propagates.

The lighting apparatus preferably includes a diffusing member to diffuse light emitted from the light source.

The lighting apparatus preferably includes an optical adjusting member placed between the light beam separating member and the light source. This clarifies the effect of separating light by the light beam separating member, which further increases light use efficiency.

It is preferred that a first optical adjusting member and a second optical adjusting member are placed between the light beam separating member and the light source, the first optical adjusting member has a substantially flat first light incident plane and a first light output plane on which a plurality of prisms extending in one direction are formed, the second optical adjusting member has a substantially flat second light incident plane and a second light output plane on which a plurality of prisms extending in one direction are formed, and the first optical adjusting member and the second optical adjusting member are arranged so that an extending direction of the prisms of the first optical adjusting member and an extending direction of the prisms of the second optical adjusting member are substantially parallel.

It is further preferred that the light beam separating member has a light input plane on which a plurality of prisms extending in one direction are formed and a substantially flat light output plane, and light output from the light beam separating member is incident on the prisms, separated into at least two different directions and output from the light output plane.

According to another embodiment of the present invention, there is provided a lighting system which includes the above-described lighting apparatus to irradiate light onto an object of irradiation from a plurality of directions, and a reflecting member to control a traveling direction of at least one light beam of light beams separated by a light beam separating member. It is thereby possible to separate the irradiation direction of light from a single light source into a plurality of directions.

It is preferred that the lighting apparatus makes at least one light beam of light beams separated in at least two different directions directly incident on the object of irradiation and makes at least one light beam incident on the object of irradiation through the reflecting member.

The reflecting member is preferably designed to gather reflected light onto the object of irradiation.

Particularly, the reflecting member preferably has a concave structure. By forming the reflecting member having a concave structure, it is possible to gather reflected light. This equalizes the light quantity of direct light and the light quantity of reflected light.

According to another embodiment of the present invention, there is provided a lighting method which includes configuring a lighting system including a light source, a light beam separating member having a light incident plane on which a plurality of prisms extending in one direction are formed and light emitted from the light source is incident and a substantially flat light output plane from which the incident light is output and made of an optically transparent material to separate light emitted from the light source into at least two different directions, and a reflecting member to control a traveling direction of at least one light beam of light beams separated by the light beam separating member; and separating light from the light source into at least two different directions by the light beam separating member and making at least one light beam directly incident on an object of irradiation and at least one light beam incident on the object of irradiation through the reflecting member. It is thereby possible to separate the irradiation direction of light from a single light source into a plurality of directions.

According to another embodiment of the present invention, there is provided a surface information acquisition apparatus which includes the above-described lighting system and a sensor to detect surface information of an object of irradiation. In this system, direct light and reflected light of light which is supplied from the lighting apparatus are irradiated onto an object of irradiation from different directions. Accordingly, a shadow is not generated even if the object of irradiation has a three-dimensional shape. Therefore, it is possible to read surface information without being interfered by a shadow when capturing an image of the object of irradiation using the sensor. Further, because the above-described lighting apparatus is used as a component of the surface information acquisition apparatus, it is possible to reduce the size and cost of the apparatus.

According to the embodiments of the present invention described above, it is possible to provide a lighting apparatus, a lighting method, a lighting system and a surface information acquisition apparatus which separate the irradiation direction of light from a single light source into a plurality of directions.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic structural view of a lighting apparatus according to a first embodiment of the present invention;

FIG. 2 is an operation explanatory view of the lighting apparatus according to the first embodiment of the present invention;

FIG. 3 is a measurement result of optical characteristics of the lighting apparatus according to the first embodiment of the present invention;

FIG. 4 is a schematic structural view of a lighting system according to the first embodiment of the present invention;

FIG. 5 is a schematic structural view of a lighting apparatus according to a second embodiment of the present invention;

FIG. 6 is an operation explanatory view of the lighting apparatus according to the second embodiment of the present invention;

FIG. 7 is a measurement result of optical characteristics of the lighting apparatus according to the second embodiment of the present invention;

FIG. 8 is a schematic structural view of a lighting system according to the second embodiment of the present invention;

FIG. 9 is a schematic vies of an irradiation direction adjustment mechanism according to a related art;

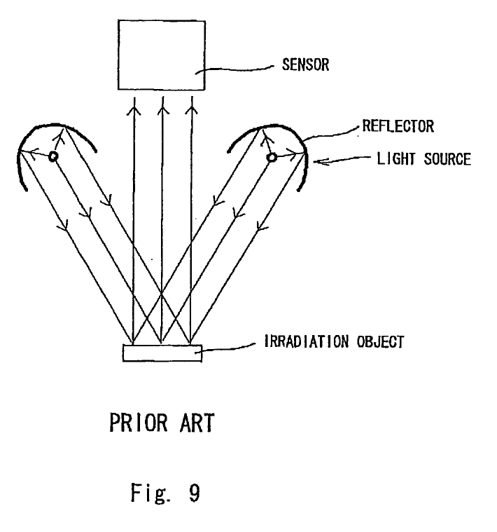

FIG. 10 is an enlarged view of an irradiation direction adjustment mechanism according to a related art; and

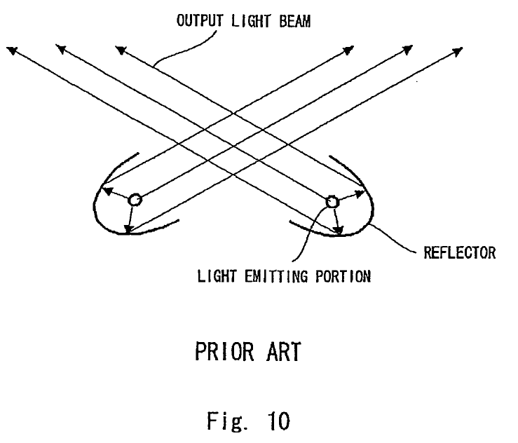

FIG. 11 is a schematic view of an irradiation direction adjustment mechanism according to a related art.

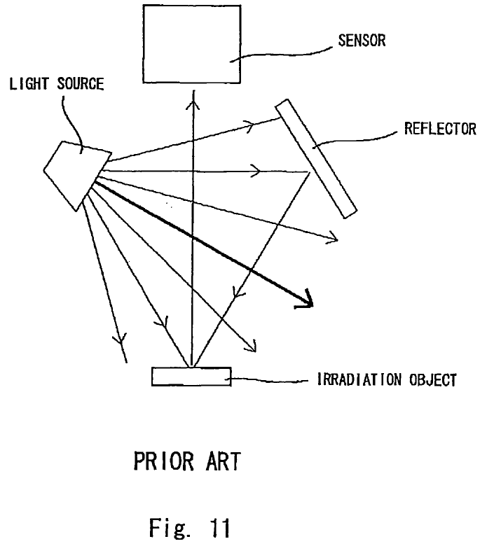

### DESCRIPTION OF THE PREFERRED EMBODIMENTS

Exemplary embodiments of the present invention are described hereinafter with reference to the drawings. Each embodiment is simplified for convenience of description.

### First Embodiment

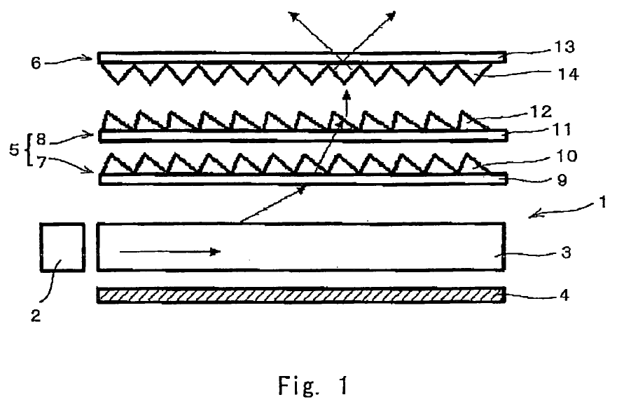

A lighting apparatus, a lighting method, a lighting system and a surface information acquisition apparatus according to a first embodiment of the present invention is described hereinafter with reference to FIGS. 1 to 4.

Referring to FIG. 1, a lighting apparatus 1 includes a light source 2, a light guide plate 3, a reflecting member 4, optical adjusting members 5, and a light beam separating member 6.

The light source 2 is a device for emitting light. The light source 2 may be configured by a light emitting diode (LED) or the like. The light source 2 is placed on one side of the light guide plate 3.

The light guide plate 3 is an optical member. The light guide plate 3 guides light incident on the side surface of the light guide plate 3 so that the light propagates therethrough and then it is output from the top surface, which is an output plane. In order that light incident on the side surface of the light guide plate 3 is output from the top surface, a plurality of reflection planes are formed on the under surface of the light guide plate 3, though not shown. The light guide plate 3 may be made of polycarbonate by injection molding. However, a method of forming the light guide plate 3 is not limited thereto.

Output light from the light guide plate 3 has a certain degree of directivity. Specifically, a direction in which the quantity of output light is maximum is tilted at a predetermined angle with respect to the normal to the output plane of the light guide plate 3.

In the following description, a light beam component which travels in the direction where a light quantity is maximum in the intensity distribution characteristics of incident light, output light and so on is referred to as a “light quantity peak beam”. The output characteristics of the light guide plate 3 according to this embodiment are set so that the direction of a light quantity peak beam of light which is output from the output plane of the light guide plate 3 is 70 degrees with respect to the normal to the output plane.

The reflecting member 4 is placed under the light guide plate 3. As the reflecting member 4, a reflecting sheet in which silver is deposited on the surface of a polyethylene terephthalate (PET) film may be used, for example. With the reflecting member 4 placed under the light guide plate 3, light which is output from the under surface of the light guide plate 3 enters the light guide plate 3 again. This enables effective use of light from the light source 2.

The optical adjusting members 5 are placed on top of the light guide plate 3. As described above, output light from the light guide plate 3 is tilted at a predetermined angle. The optical adjusting members 5 function to redirect the tilted light in a predetermined direction. In this embodiment, two optical adjusting members are used so as to redirect output light from the light guide plate 3 in the normal direction. Specifically, the optical adjusting members 5 include a first optical adjusting member 7 and a second optical adjusting member 8. However, two or more, or one optical adjusting member may be used for the optical adjusting members 5 by optically designing them appropriately in order to obtain desired optical characteristics such as the direction of output light and angle distribution.

The first optical adjusting member 7 includes a base member 9 which has a substantially flat first light incident plane 9a. Further, the first optical adjusting member 7 includes a prism 10 which is formed on a light output plane of the base member 9.

The base member 9 is an optically transparent sheet member. The base member 9 has a size large enough to substantially cover the light guide plate 3. The base member 9 may be a thick plate or arbitrary shaped base. The surface of the base member 9 is not limited to a flat surface, and it may be a three-dimensional surface.

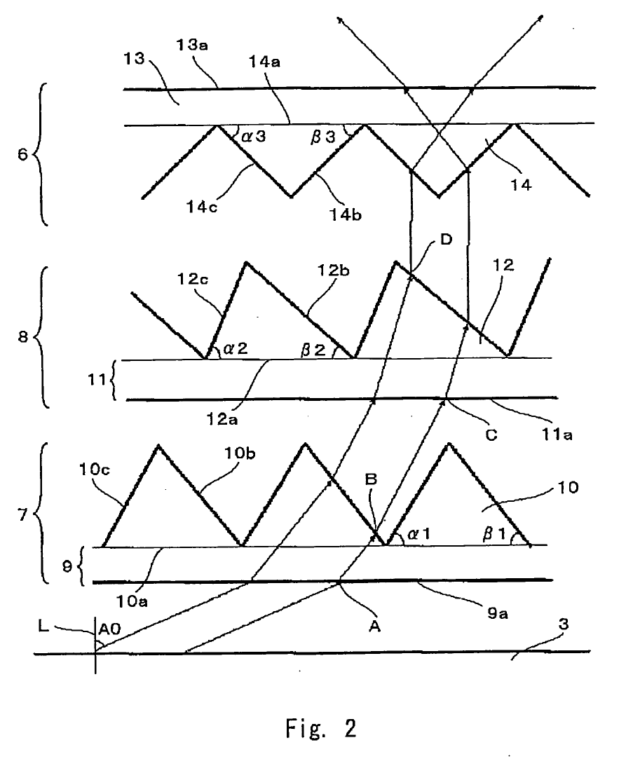

The prism 10 is a linear optical structure which extends in one direction. The cross sectional shape of the prism 10 which is orthogonal to the extending direction is substantially triangular. The cross section of the prism 10 which is orthogonal to the extending direction is referred to as a first triangular portion. Referring to FIG. 2, the first triangular portion is defined by a base side (first side) 10a, a sloping side (second side) 10b and a sloping side (third side) 10c. The first side 10a is in contact with the light output plane of the base member 9. The second side 10b and the third side 10c respectively extend at predetermined angles (β1 and α1 in FIG. 2) from the both ends of the first side 10a. Specific dimensions of the first triangular portion according to this embodiment are: the length of the first side 10a is 33 μm, the base angle α1 is 60 degrees, and the base angle β1 is 50 degrees.

A plurality of prisms 10 are formed on the light output plane of the base member 9. One plane along the extending direction or the prism 10 (which is a base surface in this embodiment) is parallel with the light output plane of the base member 9. The plurality of prisms 10 are placed at regular intervals in the direction orthogonal to the extending direction. The base angle portion of the adjacent prisms 10 are in contact with each other.

The second optical adjusting member 8 has substantially the same structure as the first optical adjusting member 7. Specifically, the second optical adjusting member 8 includes a base member 11 which has a substantially flat second light incident plane 11a. Further, the second optical adjusting member 8 includes a prism 12 which is formed on a light output plane of the base member 11.

The base member 11 is an optically transparent sheet member. The base member 11 has substantially the same size as the base member 9 of the first optical adjusting member 7. The base member 11 may be a thick plate or arbitrary shaped base. The surface of the base member 11 is not limited to a flat surface, and it may be a three-dimensional surface.

The prism 12 is a linear optical structure which extends in one direction. The cross sectional shape of the prism 12 which is orthogonal to the extending direction is substantially triangular. The cross section of the prism 12 which is orthogonal to the extending direction is referred to as a second triangular portion. Referring to FIG. 2, the second triangular portion is defined by a base side (fourth side) 12a, a sloping side (fifth side) 12b and a sloping side (sixth side) 12c. The fourth side 12a is in contact with the light output plane of the base member 11. The fifth side 12b and the sixth side 12c respectively extend at predetermined angles (β2 and α2 in FIG. 2) from the both ends of the fourth side 12a. Specific dimensions of the second triangular portion according to this embodiment are: the length of the fourth side 12a is 33 μm, the base angle α2 is 70 degrees, and the base angle β2 is 42 degrees.

A plurality of prisms 12 are formed on the light output plane of the base member 11. One plane along the extending direction of the prism 12 (which is a base surface in this embodiment) is parallel with the light output plane of the base member 11. The plurality of prisms 12 are placed at regular intervals in the direction orthogonal to the extending direction. The base angle portion of the adjacent prisms 12 are in contact with each other.

The first optical adjusting member 7 and the second optical adjusting member 8 are placed on top of one another. The first light incident plane 9a of the base member 9 of the first optical adjusting member 7 and the second light incident plane 11a of the base member 11 of the second optical adjusting member 8 are placed substantially parallel with each other. The extending direction of the prism 10 of the first optical adjusting member 7 and the extending direction of the prism 12 of the second optical adjusting member 8 are substantially parallel with each other. The prism 10 of the first optical adjusting member 7 and the second light incident plane 11a of the base member 11 of the second optical adjusting member 8 face each other. Thus, the first optical adjusting member 7 and the second optical adjusting member 8 are placed in such a way that the surfaces where the prisms are formed face the same direction.

The light beam separating member 6 is an optical member. The light beam separating member 6 separates light which is emitted from the light source 2 into two different directions. The light beam separating member 6 has an incident plane on which light emitted from the light source 2 is incident and a light output plane from which light is output after being transmitted through the light beam separating member 6. Specifically, the light beam separating member 6 includes a base member 13 which has a substantially flat light output plane 13a. Further the light beam separating member 6 includes a prism 14 which is formed on the light incident plane of the base member 13.

The base member 13 is an optically transparent sheet member. The base member 13 has substantially the same size as the base member 9 of the first optical adjusting member 7. The base member 13 may be a thick plate or arbitrary shaped base. The surface of the base member 13 is not limited to a flat surface, and it may be a three-dimensional surface.

The prism 14 is a linear optical structure which extends in one direction. The cross sectional shape of the prism 14 which is orthogonal to the extending direction is substantially triangular. The cross section of the prism 14 which is orthogonal to the extending direction is referred to as a third triangular portion. Referring to FIG. 2, the third triangular portion is defined by a base side (seventh side) 14a, a sloping side (eighth side) 14b and a sloping side (ninth side) 14c. The seventh side 14a is in contact with the light incident plane of the base member 13. The eighth side 14b and the ninth side 14c respectively extend at predetermined angles (β3 and α3 in FIG. 2) from the both ends of the seventh side 14a. Specific dimensions of the third triangular portion according to this embodiment are: the length of the seventh side 14a is 33 μm, the base angle α3 is 45 degrees, and the base angle β3 is 45 degrees.

A plurality of prisms 14 are formed on the light incident plane of the base member 13. One plane along the extending direction of the prism 14 (which is a base surface in this embodiment) is parallel with the light incident plane of the base member 13. The plurality of prisms 14 are placed at regular intervals in the direction orthogonal to the extending direction. The base angle portion of the adjacent prisms 14 are in contact with each other.

The light beam separating member 6 is placed on top of the second optical adjusting member 8. The light output plane 13a of the base member 13 of the light beam separating member 6 and the second light incident plane 11a of the base member 11 of the second optical adjusting member 8 are placed substantially parallel with each other. The extending direction of the prism 14 of the light beam separating member 6 and the extending direction of the prism 12 of the second optical adjusting member 8 are substantially parallel with each other. The prism 14 of the light beam separating member 6 and the prism 12 of the second optical adjusting member 8 face each other.

However, the positional relationship between the light beam separating member 6 and the second optical adjusting member 8 according to the present invention is not limited to the one described above. For example, the extending direction of the prism 14 of the light beam separating member 6 and the extending direction of the prism 12 of the second optical adjusting member 8 may be substantially orthogonal or have a predetermined angle. By setting the angle to a predetermined angle, it is possible to adjust the separation direction of light which is output in two different directions.

The light beam separating member 6, the first optical adjusting member 7 and the second optical adjusting member 8 (which may be hereinafter referred to simply as respective members) can be manufactured as follows.

First, roll molds for forming the prisms of the respective members are prepared. On the surfaces of the molds, the patterns corresponding to the shapes of the prisms of the respective members are formed by cutting.

Next, the base members of the respective members are prepared. A PET sheet with a thickness of 50 μm is used for the base members of this embodiment. The refractive index of the base member of the light beam separating member 6 is 1.59. The refractive index of the base members of the first optical adjusting member 7 and the second optical adjusting member 8 is 1.56. The thickness of the base members is preferably in the range of 10 to 500 μm for easy processing and handling of the respective members. Besides PET, an arbitrary optically transparent material such as an inorganic transparent material including polyethylene naphthalate, polystyrene, polycarbonate (PC), polyolefine, polypropylene, cellulose acetate and glass may be used as a material of the base members.

Ultraviolet curable resin such as aromatic acrylate is filled between the prepared base member and the mold surface. Then, ultraviolet light with a wavelength of 340 to 420 nm is irradiated on the filled ultraviolet curable resin, so that the ultraviolet curable resin is cured. After that, the base member is removed from the mold. As a result, the prism is formed on the base member. The refractive index of the prism of the light beam separating member 6 is 1.59. The refractive index of the prisms of the first optical adjusting member 7 and the second optical adjusting member 8 is 1.56. Thus, the refractive index of the prism is the same as the refractive index of the corresponding base member. An arbitrary resin material with a refractive index of 1.3 to 1.9 may be used as a material of the prisms. In the case of forming the base material and the prism using different materials as in this embodiment, it is preferred to use transparent plastic resin such as acrylic resin, urethane resin, styrene resin, epoxy resin and silicone resin. The prism may be formed using the entirely or partly the same material as the base member.

The interval (pitch) of the plurality of prisms is preferably 7 μm or longer. If the interval of the plurality of prisms is shorter than 7 μm, highly accurate mold processing is required when fabricating a mold, which increases costs.

The light beam separating member 6, the first optical adjusting member 7 and the second optical adjusting member 8 in which the plurality of prisms, which are made of ultraviolet curable resin, are formed on the base member are thereby manufactured.

The method of manufacturing the light beam separating member 6, the first optical adjusting member 7 and the second optical adjusting member 8 is not limited to the one described above, and an arbitrary known method may be used. For example, the base members may be formed using thermoplastic resin. Then, molds having surfaces on which the patterns corresponding to the shapes of the prisms of the respective members are formed by cutting may be hot pressed against the corresponding base members, so that the patterns of the molds are transferred. In this manner, the prism may be directly formed on the base member itself by such a thermal transfer method or the like. Alternatively, the prism may be formed on the base member using the same material as the base member by a known extrusion molding method, a press molding method, or an injection molding method of injecting molten resin into the mold.

To describe the way that the lighting apparatus 1 having the above-described structure outputs light, a process of a change in a light path within the lighting apparatus 1 is described hereinafter with reference to FIG. 2.

In FIG. 2, an arrow which illustrates a light beam path indicates a change in the light path of a light quantity peak beam. As described earlier, the light guide plate 3 in which the output angle of a light quantity peak beam is 70 degrees is used in this embodiment.

The respective members are arranged in such a way that light which is output from the light guide plate 3 and incident on the first optical adjusting member 7 passes through the plane perpendicular to the extending direction of the prisms of the respective members. Further, the respective members are formed in such a way that the triangular portions, which are the cross sections of the prisms, have the angular relationship shown in FIG. 2. The horizontal positional relationship of the prisms of the respective members is arbitrary. For example, there is no restriction that the sixth side 12c should be placed immediately above the second side 10b.

First, light is output from the light guide plate 3 into the air. The angle A0 of a light quantity peak beam of the light is 70 degrees with respect to the normal L to the light guide plate 3.

The light quantity peak beam from the light guide plate 3 is incident on a point A of the first light incident plane 9a of the base member 9 of the first optical adjusting member 7. The incident angle of the light quantity peak beam is 70 degrees, which is the same as the angle A0. At the incident point A, the light quantity peak beam is refracted due to a difference in refractive index between the air and the base member 9. As a result, the output direction of the light quantity peak beam is tilted toward the normal to the light guide plate 3 compared with the incident direction.

The light quantity peak beam which is incident on the incident point A is transmitted through the prism 10 of the first optical adjusting member 7. The light quantity peak beam reaches a point B on a first light gathering plane (the second side 10b) and is output into the air again. At this point, the light quantity peak beam is refracted due to a difference in refractive index between the prism 10 and the air and the slope of the second side 10b. As a result, the output direction of the light quantity peak beam is further tilted toward the normal to the light guide plate 3 compared with the incident direction.

The light quantity peak beam which is output from the first optical adjusting member 7 is incident on a point C on the second light incident plane 11a of the base member 11 of the second optical adjusting member 8. At the incident point C, the light quantity peak beam is refracted due to a difference in refractive index between the air and the base member 11. As a result, the output direction of the light quantity peak beam is further tilted toward the normal to the light guide plate 3 compared with the incident direction.

The light quantity peak beam which is incident on the incident point C is transmitted through the prism 12 of the second optical adjusting member 8. The light quantity peak beam reaches a point D on a second light gathering plane (the fifth side 12b) and is output into the air again. At this point, the light quantity peak beam is refracted due to a difference in refractive index between the prism 12 and the air and the slope of the fifth side 12b. As a result, the output direction of the light quantity peak beam is further tilted toward the normal to the light guide plate 3 compared with the incident direction.

Consequently, the output direction of the light quantity peak beam which is output from the second optical adjusting member 8 is substantially the same as the normal to the light guide plate 3.

The light quantity peak beam which is output from the second optical adjusting member 8 is incident on the light incident planes (the eighth side 14b and the ninth side 14c) of the prism 14 of the light beam separating member 6. At this point, the light quantity peak beam whose light path has been adjusted by the optical adjusting members 5 as described above is incident on the prism 14 in the direction substantially normal to the light guide plate 3. In other words, the light quantity peak beam is incident on the prism 14 in the direction substantially perpendicular to the light output plane 13a of the light beam separating member 6. On each light incident plane, the light quantity peak beam is refracted due to the refractive index and the slope of the prism 14. Because the output direction differs depending on the light incident plane, the light quantity peak beam is separated into two directions. As a result, the main irradiation direction of the light quantity peak beam from the light output plane 13a becomes two directions. Specifically, the light quantity peak beam which is incident on the eighth side 14b is refracted to the left of FIG. 2 and output. On the other hand, the light quantity peak beam which is incident on the ninth side 14c is refracted to the right of FIG. 2 and output.

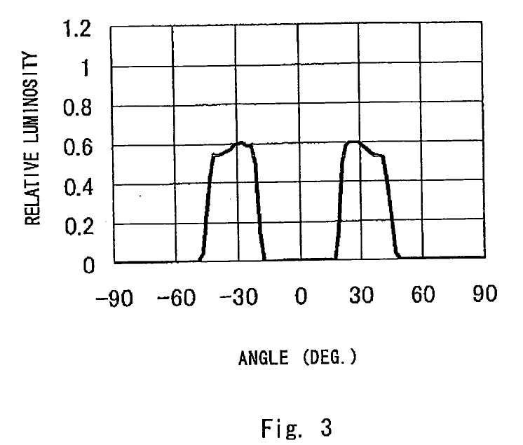

Evaluation of optical characteristics of the lighting apparatus 1 according to this embodiment is described hereinafter. For measurement of optical characteristics, angle-luminosity distribution characteristics of output light are measured using a photometer. FIG. 3 shows a measurement result. In FIG. 3, the horizontal axis indicates an angle in the direction of luminosity measurement. The normal to the light guide plate 3 is zero degree, and the direction in which light emitted from an LED, which is the light source 2, travels is the plus direction. A point of measurement is immediately above the light beam separating member 6 of FIG. 1, and luminosity at the central part of the light beam separating member 6 is measured. The vertical axis indicates relative luminosity. A measurement value is standardized by setting luminosity at the zero degree (normal direction) immediately above and the central part of the optical adjusting members 5 to 1.

As shown in FIG. 3, in the lighting apparatus 1 of this embodiment, the irradiation direction of a light quantity peak beam is clearly separated into plus and minus two directions. Specifically, a light quantity peak beam is separated into two light beam centering on about 30 degrees, which have substantially the same luminous distribution and peak.

In this embodiment, an optical member with a refractive index of 1.59 in which the base angles α3 and β3 of the triangular portion are both 45 degrees is used as the light beam separating member 6. The lighting apparatus with two irradiation directions whose light quantity peak beam is output mainly in the directions at plus-minus 30 degrees is thereby achieved. The irradiation angle, however, can be adjusted by changing the three parameters. For example, in the case where a material with a refractive index of 1.59 is used as the light beam separating member 6, the base angles α3 and β3 of the triangular portion may both be set to 60 degrees. In such a case, the irradiation direction of a light quantity peak beam is plus-minus 50 degrees. Further, the base angles α3 and β3 of the triangular portion may both be set individually. This allows irradiation in asymmetrical directions.

A lighting system 100 which uses the lighting apparatus 1 having the above-described structure is described hereinafter.

The lighting system 100 includes the lighting apparatus 1 and a reflecting member 115.

Output light from the lighting apparatus 1 is separated into two directions as described in the foregoing. The position and the angle of the lighting apparatus 1 are adjusted so that one of separated light beams is directly irradiated onto an object 116 of irradiation. Specifically, the lighting apparatus 1 makes one separated beam of light beams which are separated in two different directions directly incident on the object 116 of irradiation. Further, the lighting apparatus 1 makes the other separated beam incident on the object 116 of irradiation through the reflecting member 115.

The reflecting member 115 controls a light beam traveling direction of at least one of light beams which are separated by the light beam separating member 6. Thus, the position and the angle of the reflecting member 115 are adjusted so that one separated light from the lighting apparatus 1 is guided to the reflecting member 115 and reflected light on the reflecting member 115 is guided to the object 116 of irradiation. Specifically, the reflecting member 115 is placed in the position and the angle that irradiate reflected light onto the object 116 of irradiation so as to eliminate a shadow generated due to direct irradiation of light onto the object 116 of irradiation.

In the above-described structure, output light from the light beam separating member 6 is clearly separated. Further, output light from the light beam separating member 6 has characteristics that an angular width of each separated light beam is narrow. The lighting system 100 can thereby guide a large part of output light to the object 116 of irradiation directly or through the reflecting member 115. Thus, direct light and reflected light of light which is supplied from the lighting apparatus 1 are irradiated onto the object 116 of irradiation from different directions. Accordingly, no shadow is generated even if the object 116 of irradiation has a three dimensional shape. Further, high light use efficiency is achieved.

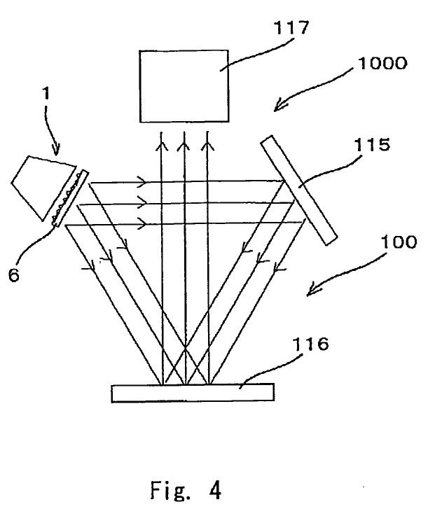

It is preferred to configure a surface information acquisition apparatus 1000 by incorporating a sensor 117 which detects surface information of the object 116 of irradiation into the lighting system 100 having the above-described structure as shown in FIG. 4. The surface information acquisition apparatus 1000 can read surface information without being interfered by a shadow when capturing an image of the object 116 of irradiation using the sensor 117.

The object 116 of irradiation is held by a stage portion, which is not shown.

Although an LED is used as the light source of this embodiment, it is not limited thereto. For example, a cold cathode fluorescent lamp (CCFL) may be used as the light source.

Although the cross sectional shapes of the prisms of this embodiment are triangular, they is not limited thereto. The shape, size and so on of the prisms may be altered as appropriate according to optical design or the like.

The optical adjusting member(s) of this embodiment is not limited to the above-described examples. The shape and size of the optical adjusting member(s) may be altered as appropriate in each member. In this case, the shape and size of the optical adjusting member(s) are preferably designed so as to obtain desired optical characteristics such as the direction of output light to the light beam separating member, angle distribution and so on and to reduce visual fluctuations such as unevenness and moire.

Although the members are placed in the order of the first optical adjusting member, the second optical adjusting member and the light beam separating member from the light incident side in this embodiment, it is not limited thereto. For example, a diffusing sheet or the like may be placed as appropriate on top of the light beam separating member, under the first optical adjusting member, between the members and so on according to design of optical characteristics

### Second Embodiment

A lighting apparatus according to the present invention is not limited to have the above-described structure.

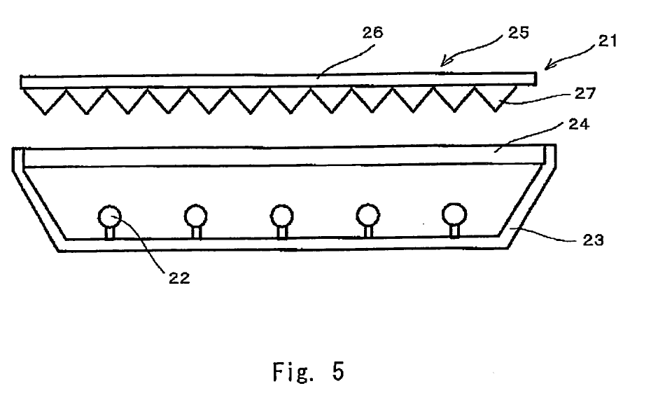

For example, a lighting apparatus 21 shown in FIG. 5 has the same function and advantage as the lighting apparatus 1 of the first embodiment.

Referring to FIG. 5, the lighting apparatus 21 includes a light source 22, a reflecting plate 23, a diffusing member 24 and a light beam separating member 25.

The light source 22 is a device for emitting light. A CCFL with a diameter of 4 mm is used as the light source 22 of this embodiment. The light source 22 is arranged uniformly at a pitch of 20 mm.

The reflecting plate 23 has a structure that a reflection plane for reflecting output light from the light source 22 is formed on the inner surface of a case with an open top. A plurality of light sources 22 are placed on the inner bottom surface of the reflecting plate 23. Thus, the reflecting plate 23 reflects light which is emitted from a light emitting portion of the light source 22 and output to the backside of the lighting apparatus in the direction of the top side, thereby enhancing light use efficiency. In this embodiment, a reflecting plate in which titanium oxide is coated on the inner surface of a case that is made of polycarbonate resin is used.

The diffusing member 24 is fitted in the case of the reflecting plate 23 so as to cover the opening of the case. The diffusing member 24 is made of an acrylic resin plate in which translucent white bead-shaped light diffusing materials are dispersed. The diffusing member 24 of this embodiment has a thickness of 6 mm and a haze of 95%.

The light beam separating member 25 has the same structure as the light beam separating member 6 of the first embodiment. Specifically, the light beam separating member 25 includes an optically transparent base member 26 and a plurality of prisms 27 formed on a light incident plane of the base member 26.

The base member 26 is an optically transparent sheet member. The base member 26 has a size large enough to substantially cover the diffusing member 24. The base member 26 may be a thick plate or arbitrary shaped base. The surface of the base member 26 is not limited to a flat surface, and it may be a three-dimensional surface.

In this embodiment, a polyethylene terephthalate (PET) sheet with a thickness of 100 μm is used as the base member 26. The refractive index of the base member 26 is 1.56. Besides PET, an arbitrary optically transparent material such as an inorganic transparent material including polyethylene naphthalate, polystyrene, polycarbonate (PC), polyolefine, polypropylene, cellulose acetate and glass may be used as a material of the base member 26.

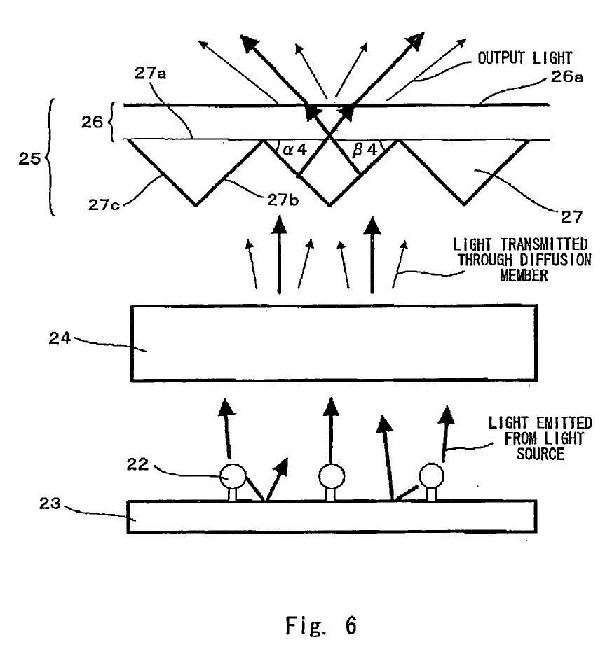

The prism 27 is a linear optical structure which extends in one direction. The cross sectional shape of the prism 27 which is orthogonal to the extending direction is substantially inverted triangular. The cross section of the prism 27 which is orthogonal to the extending direction is referred to as a fourth triangular portion. Referring to FIG. 6, the fourth triangular portion is defined by a base side (tenth side) 27a, a sloping side (eleventh side) 27b and a sloping side (twelfth side) 27c. The tenth side 27a is in contact with the light incident plane of the base member 26. The eleventh side 27b and the twelfth side 27c respectively extend at predetermined angles (β4 and α4 in FIG. 6) from the both ends of the tenth side 27a. Specific dimensions of the fourth triangular portion according to this embodiment are: the length of the tenth side 27a is 33 μm, the base angle α4 is 45 degrees, and the base angle β4 is 45 degrees. The refractive index of the prism 27 is 1.56.

A plurality of prisms 27 are formed on the light incident plane of the base member 26. One plane along the extending direction of the prism 27 (which is a base surface in this embodiment) is parallel with the light incident plane of the base member 26. The plurality of prisms 27 are placed at regular intervals in the direction orthogonal to the extending direction. The base angle portions of the adjacent prisms 27 are in contact with each other.

The light beam separating member 25 is placed on top of the diffusing member 24. The prisms 27 of the light beam separating member 25 and the diffusing member 24 face each other. The light output plane 26a of the base member 26 of the light beam separating member 25 and the light output plane of the diffusing member 24 are placed substantially parallel with each other. A method of manufacturing the light beam separating member 25 is the same as described in the first embodiment and thus not described herein.

To describe the way that the lighting apparatus 21 having the above-described structure outputs light, a process of a change in a light path within the lighting apparatus 21 is described hereinafter with reference to FIG. 6.

Light emitted from the light source 22 is incident on the diffusing member 24 directly or after being reflected by the reflecting plate 23. The light incident on the diffusing member 24 is diffused by the surface and inner light diffusing structure of the diffusing member 24. The diffused light is output toward the top of the lighting apparatus 21 at a wider angle with its light quantity peak in the direction normal to the inner bottom surface of the reflecting plate 23.

The output light from the diffusing member 24 is incident on the eleventh side 27b and the twelfth side 27c of the prism 27 of the light beam separating member 25. At this point, a light quantity peak beam of the incident light is incident on the prism 27 in the direction normal to the inner bottom surface of the reflecting plate 23 as described above. In other words, a light quantity peak beam of the incident light is incident on the prism 27 in the direction normal to a light output plane 26a of the light beam separating member 25. The light quantity peak beam is refracted due to the refractive index and the slope of the prism 27. The main output direction of the light quantity peak beam differs depending on the sloping side on which the light quantity peak beam is incident. Specifically, the light quantity peak beam which is incident on the eleventh side 27b is refracted to the left of FIG. 6 and output. On the other hand, the light quantity peak beam which is incident on the twelfth side 27c is refracted to the right of FIG. 6 and output. As a result, the irradiation direction of the light quantity peak beam is separated into two directions.

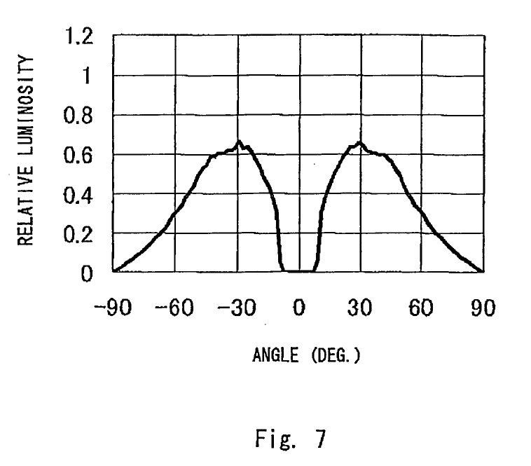

Evaluation of optical characteristics of the lighting apparatus 21 according to this embodiment is described hereinafter. For measurement of optical characteristics, angle-luminosity distribution characteristics of output light are measured using a photometer. FIG. 7 shows a measurement result. In FIG. 7, the horizontal axis indicates an angle in the direction of luminosity measurement. The normal to the inner bottom surface of the reflecting plate 23 is zero degree, and the direction perpendicular to the extending direction of a CCFL, which is a light source, is a measurement direction.

A point of measurement is immediately above the light beam separating member 25 of FIG. 6, and luminosity at the central part of the light beam separating member 25 is measured. The vertical axis indicates relative luminosity. A measurement value is standardized by setting luminosity at the zero degree (normal direction) immediately above and the central part of the diffusing member 24 to 1.

As shown in FIG. 7, in the lighting apparatus 21 of this embodiment, the irradiation direction of a light quantity peak beam is clearly separated into two directions. Specifically, a light quantity peak beam is separated into two light beams centering on about 45 degrees, which have substantially the same luminous distribution and peak.

A lighting system 200 which uses the lighting apparatus 21 having the above-described structure is described hereinafter.

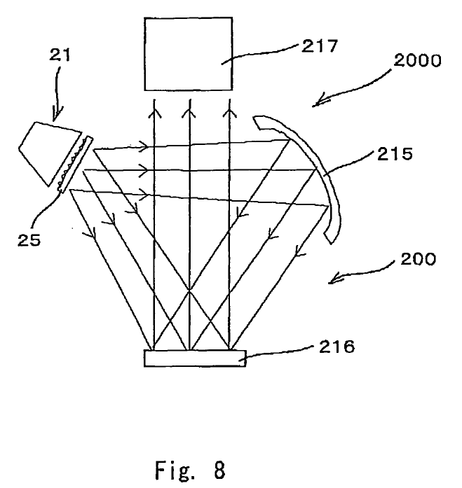

Referring to FIG. 8, the lighting system 200 includes the lighting apparatus 21 and a reflecting member 215.

Output light from the lighting apparatus 21 is separated into two directions as described in the foregoing. The position and the angle of the lighting apparatus 21 are adjusted so that one of separated light beams is directly irradiated onto an object 216 of irradiation. Specifically, the lighting apparatus 21 makes one separated beam of light beams which are separated in two different directions directly incident on the object 216 of irradiation. Further, the lighting apparatus 21 makes the other separated beam incident on the object 216 of irradiation through the reflecting member 215.

The reflecting member 215 controls a light beam traveling direction of at least one of light beams which are separated by the light beam separating member 25. Thus, the position and the angle of the reflecting member 215 are adjusted so that one separated light from the lighting apparatus 21 is guided to the reflecting member 215 and reflected light on the reflecting member 215 is guided to the object 216 of irradiation. Specifically, the reflecting member 215 is placed in the position and the angle that irradiate reflected light onto the object 216 of irradiation so as to eliminate a shadow generated due to direct irradiation of light onto the object 216 of irradiation.

The reflecting member 215 of this embodiment has a concave structure. The curvature and the placement angle of the reflecting member 215 are adjusted so as to guide reflected light to the object 216 of irradiation.

The reason that the reflecting member 215 of this embodiment has a concave structure is described in detail hereinbelow. As shown in FIG. 7, the lighting apparatus 21 according to this embodiment outputs light so that each separated light beam has a wide viewing angle. If a simple flat reflecting member is used for such separated light, light is spread before reflected light reaches an object of irradiation. As a result, the proportion of light irradiated onto an object of irradiation is such that the light quantity of reflected light is smaller than that of direct light, and therefore the effect of eliminating a shadow or the like is not sufficiently obtained.

To address this issue, the reflecting member 215 of this embodiment is concave-shaped to gather reflected light, so as to substantially equalize the light quantity of reflected light and the light quantity of direct light. This enables multi-directional irradiation.

In the above-described structure, direct light and reflected light of light which is supplied from the lighting apparatus 21 are irradiated onto the object 216 of irradiation from different directions at substantially the same light quantity. Accordingly, a shadow is not generated even if the object 216 of irradiation has a three-dimensional shape.

It is preferred to configure a surface information acquisition apparatus 2000 by incorporating a sensor 217 which detects surface information of the object 216 of irradiation into the lighting system 200 having the above-described structure as shown in FIG. 8. The surface information acquisition apparatus 2000 can read surface information without being interfered by a shadow when capturing an image of the object 216 of irradiation using the sensor 217.

The object 216 of irradiation is held by a stage portion, which is not shown.

Although a CCFL is used as the light source 22 of this embodiment, it is not limited thereto. For example, LED or the like may be used as the light source 22. In this case, it is preferred to arrange LED or the like linearly or planarly.

Although the cross sectional shapes of the prisms of this embodiment are triangular, they are not limited thereto. The shape, size and so on of the prisms may be altered as appropriate according to optical design or the like.

Although the members are separated from each other in the figures, the members may be separated in such a manner or adjacent to each other.

Although the embodiments of the lighting apparatus, the lighting method, the lighting system and the surface information acquisition apparatus are described in the foregoing, various changes and modifications may be made without departing from the scope of the invention. For example, if the prisms of the light beam separating member are shaped like a triangular pyramid, a light quantity peak beam can be separated into three directions. Further, if the prisms of the light beam separating member are shaped like a quadrangular pyramid, a light quantity peak beam can be separated into four directions. In this manner, by making the prisms of the light beam separating member have polyhedral pyramid shapes, it is possible to separate a light quantity peak beam into multiple directions corresponding to the number of sloping planes of the polyhedral pyramid.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A lighting apparatus comprising:
a light source; and
a light beam separating member to separate light emitted from the light source into at least two different directions, wherein the light beam separating member is composed of an optical transparent member and has a light incident plane on which light emitted from the light source is incident and a light output plane from which the light is output after being transmitted through the light beam separating member.

2. The lighting apparatus according to claim 1, wherein a plurality of prisms extending in one direction are formed on the light incident plane of the light beam separating member, and the light output plane of the light beam separating member is substantially flat.

3. The lighting apparatus according to claim 1, wherein the light beam separating member is placed so that a peak beam traveling in a direction where a light quantity is maximum in intensity distribution characteristics of light incident on the light beam separating member is incident in a direction substantially perpendicular to the light output plane.

4. The lighting apparatus according to claim 1, further comprising:
a light guide plate through which light emitted from the light source propagates.

5. The lighting apparatus according to claim 1, further comprising:
a diffusing member to diffuse light emitted from the light source.

6. The lighting apparatus according to claim 1, further comprising:
an optical adjusting member placed between the light beam separating member and the light source.

7. The lighting apparatus according to claim 6, wherein a first optical adjusting member and a second optical adjusting member are placed between the light beam separating member and the light source, he first optical adjusting member has a substantially flat first light incident plane and a first light output plane on which a plurality of prisms extending in one direction are formed,
the second optical adjusting member has a substantially flat second light incident plane and a second light output plane on which a plurality of prisms extending in one direction are formed, and
the first optical adjusting member and the second optical adjusting member are arranged so that an extending direction of the prisms of the first optical adjusting member and an extending direction of the prisms of the second optical adjusting member are substantially parallel.

8. The lighting apparatus according to claim 1, wherein the light beam separating member has a light input plane on which a plurality of prisms extending in one direction are formed and a substantially flat light output plane, and
light output from the light beam separating member is incident on the prisms, separated into at least two different directions and output from the light output plane.

9. A lighting system comprising:
the lighting apparatus according to claim 1 to irradiate light onto an object of irradiation from a plurality of directions; and a reflecting member to control a traveling direction of at least one light beam of light beams separated by a light beam separating member.

10. The lighting apparatus according to claim 9, wherein the lighting apparatus makes at least one light beam of light beams separated in at least two different directions directly incident on the object of irradiation and makes at least one light beam incident on the object of irradiation through the reflecting member.

11. The lighting apparatus according to claim 10, wherein the reflecting member is designed to gather reflected light onto the object of irradiation.

12. The lighting apparatus according to claim 11, wherein the reflecting member has a concave structure.

13. A lighting method comprising:
configuring a lighting system including a light source, a light beam separating member having a light incident plane on which a plurality of prisms extending in one direction are formed and light emitted from the light source is incident and a substantially flat light output plane from which the incident light is output and made of an optically transparent material to separate light emitted from the light source into at least two different directions, and a reflecting member to control a traveling direction of at least one light beam of light beams separated by the light beam separating member; and
separating light from the light source into at least two different directions by the light beam separating member and making at least one light beam directly incident on an object of irradiation and at least one light beam incident on the object of irradiation through the reflecting member.

14. A surface information acquisition apparatus comprising:
the lighting system according to claim 9; and
a sensor to detect surface information of an object of irradiation.
